(19) United States
(12) Patent Application Publication
(10) Pub. No.: US 2003/0128688 A1
(43) Pub. Date: Jul. 10, 2003

(54) ATM based MPLS-LER system and method for establishing connection

(75) Inventor: Young Kung Kim, Seoul (KR)

Correspondence Address: FLESHNER & KIM, LLP, P.O. Box 221200, Chantilly, VA, 20153-1200, US

(73) Assignee: LG Electronics Inc.

(21) Appl. No.: 10/327,909

(22) Filed: Dec. 26, 2002

(30) Foreign Application Priority Data
Dec. 26, 2001 (KR) 2001-85291
Oct. 30, 2002 (KR) 2002-66599

(51) Int. Cl. H04L 12/28

(52) U.S. Cl. 370/351; 370/395.1

(57) ABSTRACT

The present invention relates to a matching structure of forwarding engines (FEs) of an Asynchronous Transfer Mode (ATM) based Multi Protocol Label Switching-Label Edge Router (MPLS-LER) system for transmission of IP/MPLS packets which results in the decrease of the connections required within the system for such transmission and a method for connection in accordance with the provided matching structure. In the preferred embodiment of the present invention, by utilizing pre-established internal connections, additional IP equipments or Label Switching Paths (LSPs) are connected. Thus, no additional connections are required for additional equipments, while all the connections supported by the Line Interface Modules (LIMs) are provided. Consequently, according to the present invention, due to the decreased number of required connections, the repair and maintenance of the connections become simple. Further, because any additional connections to be made for additional IP equipments or LSPs are limited at the FEs, the connection establishment is conducted in a simple and expeditiously manner.

### BACKGROUND OF THE INVENTION

1. Field of the Invention

The present invention relates to an Asynchronous Transfer Mode (ATM) system, and more particularly to an ATM based Multi Protocol Label Switching (MPLS)—Label Edge Router (LER) system and a method for establishing connection for such system.

2. Background of the Related Art

The increase in the number of Internet users and the accompanying increase in the amount of traffic on the Internet are degrading the quality of the Internet services. Additionally, the change in the types of application services provided through the Internet contributes to the increase of the Internet traffic, which threatens the service quality. This trend of increasing traffic and degrading service quality is getting worse as time goes on.

In order to improve the transmission capability on the Internet backbone network which has reached its maximum capacity as described above, various technologies have been introduced. Among such technologies, the most popular includes combining the layer 2 switching technique and the layer 3 routing technique for improving the backbone network's capacity. Thus, many equipment manufacturers have conducted extensive research and product development regarding this technology.

However, in order to use such newly developed technologies in the Internet backbone network, it is important to standardize the relevant technologies. Thus, a Multi Protocol Label Switching (MPLS) Working Group was organized as an official working group of the Internet Engineering Task Force (IETF) and this group has conducted the general standardization of the MPLS technologies.

For implementing an LER on an ATM based MPLS through the MPLS related technologies, the ordinary ATM exchange system needs to have additional software and hardware functions. For example, for the software function, various IP/MPLS control software, such as Transmission Control Protocol Internet Protocol (TCP/IP), routing protocol, MPLS signaling protocol, etc., is necessary. Further, as hardware, a processor board on which the above-mentioned IP/MPLS control software and an Forwarding Engines (FE) board which may process IP/MPLS packets and an MG (Merging) board for preventing the interleaving of ATM cells are required.

The related art structure of an LER on an ATM based MPLS illustrated in FIG. 1 comprises multiple line interface modules of the IP side (LIM) 11-1, 11-2, multiple FEs of the IP side 12-1, 12-2, multiple MGs of the IP side 13-1, 13-2, an ATM control board 14, an IP/MPLS control board 15, a switch fabric 16, multiple FEs of the label switching router (LSR) side 17-1, 17-2, multiple MGs of the LSR side 18-1, 18-2 and multiple LIMs of the LSR side 19-1, 19-2. The FEs 12-1, 12-2, 17-1, 17-2 and the IP/MPLS control board 15 are the modules added for the IP or the MPLS. The other modules are same as they are used in an ordinary ATM exchange.

The LIMs 11-1, 11-2, 19-1, 19-2 are boards that process ATM traffic, comprising input/output ports. These LIMs conduct matching functions to external links or lines.

The FEs 12-1, 12-2, 17-1, 17-2 are blocks conducting the function of the layer 3 forwarding for transmission of IP or MPLS packets to relevant destinations. These FEs include the segmentation and reassembly (SAR) function for constructing layer 3 packets by assembling ATM cells and for segmenting layer 3 packets back into ATM cells. Normally, the FEs are installed in the input terminal.

The MGs 13-1, 13-2, 18-1, 18-2 are blocks intended to resolve the problem of cell interleaving which may occur when several ATM cells which have been transmitted from the FEs 12-1, 12-2, 17-1, 17-2 are transmitted via the switch fabric 16 through the same ATM connection. The MGs are normally installed in the output terminal. However, because the MGs 13-1, 13-2, 18-1, 18-2 merely conduct the merging function to prevent interleaving in the cell unit, they may not process the data in the packet unit format.

The ATM control board 14 is a block where software for call processing, connection control, repair and maintenance, billing and statistics related to ATM cells is executed.

The IP/MPLS control board 15 is a block which conducts the LER control function. On the IP/MPLS control board 15, various types of software is installed, including TCP/IP protocol stack, routing protocol for managing routing information, label distribution protocol (LDP) for controlling label switched paths (LSP), and other signaling protocols.

The switch fabric 16 is a board which switches and transmits input ATM cells which have been transmitted from the FEs 12-1, 12-2, 17-1, 17-2 to the relevant output ports through the MGs 13-1,13-2, 18-1, 18-2.

The related art structure for connecting an exchange to process IP/MPLS packets on the above-explained ATM based MPLS-LER system is explained in more detail below.

First, if the connection to an IP equipment comprising a router is intended, the following connections are established to transmit and receive IP packets to and from the IP equipment of the MPLS network as illustrated in FIG. 2.

Specifically, a connection is established so that IP packets received from the IP equipment may be transmitted from the LIM of the IP side 11-1 to the FE 12-1 of the IP side through the ATM traffic. The connection is then made so that the transmission to the IP/MPLS control board 15 may be made through the switch fabric 15 when the FE 12-1 of the IP side has conducted the forwarding.

Thereafter, ATM cells are transmitted to the MG 13-1 of the IP side through the switch fabric 16 by the LER control of the IP/MPLS control board 15. Then, when the MG 13-1 of the IP side has conducted the merging function to prevent the cell interleaving, a virtual channel (VC) merging connection is established so that the transmission to the IP equipment may be conducted via the LIM 11-1 of the IP side.

Also, for ATM cells transmitted from all of the FEs 12-1, 12-2, 17-1, 17-2 to be received at the MG 13-1 of the IP side through the switch fabric 16. Then to be transmitted to the IP equipment through the LIM 11-1 of the IP side through VC merging connections after the merging function conducted at the MG 13-1 of the IP side to prevent the cell interleaving, connections are made with respect to all the FEs 12-1, 12-2, 17-1, 17-2 installed in the system.

Further, if additional IP equipment is to be connected to the system, all the connections described above should be reestablished with respect to the new IP equipment. Thus, the number of lines to be merged with respect to the FEs 12-1, 12-2, 17-1, 17-2 becomes the number of routers connected to the system.

Second, if the connection is to be made for control message transmission to the LSR, the following connections need to be made in order to transmit and receive routing messages and signaling messages to and from the LSR of the MPLS network as shown in FIG. 3.

A connection is made so that routing messages and signaling messages may be transmitted to the MG 18-1 of the LSR side, to the LIM 19-1 of the LSR side and then to the LSR through the switch fabric 16 by the LER control of the IP/MPLS control board 15.

Then, a connection is made so that messages may be transmitted to the IP/MPLS control board 15 through the switch fabric 16 after the FE 17-1 of the LSR side has forwarded the routing messages and signaling messages received from the LSR through the LIM 19-1 of the LSR side.

Third, if the LSP connection is to be made for transmission of MPLS packets, the following connections are made in order to transmit MPLS packets of the ATM cell format to the LSR of the MPLS network as shown in FIG. 4.

After the FE 12-1 of the IP side has received MPLS packets of the ATM cell format and forwarded them, the packets are transmitted to the MG 18-1 of the LSR side through the switch fabric 16.

Then, the MG 18-1 of the LSR conducts the merging function to prevent cell interleaving. Thereafter, a connection is made so that transmission may be conducted to the LSR via the LIM 19-1 of the LSR side. At this time, VC merging connections must be established with respect to all the FEs 12-1, 12-2, 17-1, 17-2 of the system.

Fourth, if the LSP connection is to be made for receiving MPLS packets, the following connections are made in order to receive MPLS packets of the ATM cell format from the LSR of the MPLS network as shown in FIG. 5.

A connection is made so that MPLS packets of the ATM cell format received from the LSR may be processed for the ATM traffic and then be transmitted to the FE 17-1 of the LSR side.

The related art ATM based MPLS-LER system has various disadvantages. For example, whenever an IP equipment device is added or whenever an LSP towards the MPLS network is created, merging connections need to be made within the system among the switch fabric, MGs, LIMs and the EP equipment or among the switch fabric, MGs, LIMs and the LSR for each and every FE within the system. Thus, as the number of IP equipments or LSPs to be connected increases, the number of connections required within the switch multiplies (i.e., the number of connections within the switch equals the number of required connections multiplied by the number of FEs). For example, if the number of required connections is ‘M’ and the number of FEs is ‘N’, the number of connections necessary to be made within the switch is ‘M*N’.

Additionally, when a new IP equipment or an LSP is added, all FEs must be individually connected to the MG board. Thus, even with a little bit of increase in the number of IP equipments or LSPs, the internal connections required within a system increase too much that it becomes very difficult to manage the connections. Further, the upper limit of the number of connections of a system may be exceeded due to the necessity for a large number of connections in the related art.

The above references are incorporated by reference herein where appropriate for appropriate teachings of additional or alternative details, features and/or technical background.

### SUMMARY OF THE INVENTION

An object of the present invention is to solve at least the above problems and/or advantages and to provide at least the advantages described hereinafter.

It is another object of the present invention to provide a system and method to establish connections for IP/MPLS packet transmission in an ATM based MPLS-LER system, an FE matching structure and a method for connection, through which the number of the system's internal connections required for transmitting IP/MPLS packets is decreased.

More particularly, in establishing connection for transmitting Internet Protocol (IP)/MPLS packets in an ATM based MPLS system which conducts the function of a LER, the present invention provides a matching structure of forwarding engines (FEs), which resultantly may reduce the number of the system's internal connections required for transmission of IP/MPLS packets. Also, the present invention provides a method for establishing connections according to such matching structure.

It is another object of the present invention to utilize the internal connections which have already been established within an ATM based MPLS-LER system for connection of additional IP equipments or LSPs and, thus, to enable the pre-established connections to be shared.

It is another object of the present invention to provide a system and method for which all the connections for the LIMs are supported without making additional connections within the system, thereby making it convenient to repair and maintain the connections because the required number of connections is far less than the number of connections required in the related art.

It is another object of the present invention to provide a system and method that uses FEs to control and limit all additional connections that need to be made within an ATM based MPLS-LER system, separately from the preestablished basic connections, for any additional IP equipment or LSP. Thus, the connections may be established in a simple and expeditious manner according to the present invention.

In order to achieve at least the above objects in whole or in parts, there is provided an ATM based MPLS-LER system, which includes a number of LIMs for processing ATM traffic by conducting the matching with IP equipments or LSRs; a number of input FEs for transmitting IP or MPLS packets received through the LIMs to relevant destinations by conducting the forwarding function. There is also provided a switch fabric for switching ATM cells transmitted from the input FEs to their relevant output ports; and a number of output FEs for transmitting IP or MPLS packets received through the switch fabric to relevant destinations through the LIMs by conducting the forwarding function.

Preferably, the input FEs, installed at the input part, transmit IP or MPLS packets which have been received through relevant LEMs to the output FEs through the switch fabric by conducting the IP header or MPLS label look-up function. Further, the output FEs, installed at the output part, transmit IP or MPLS packets which have been received through the switch fabric to destinations searched by the IP header or MPLS label look-up function through the relevant LIMs.

Preferably, the input FEs attach pre-determined routing tags to be used at the switch fabric to ATM cells and transmit the routing tag-attached ATM cells for transmitting IP or MPLS packets, which have been received through the LIMs, to the output FEs. Further, the input FEs and the output FEs establish connections for transmission and receipt of control messages to and from an IP/MPLS board.

Additionally, in order to achieve at least the above objects in whole or in parts, there is also provided a method for establishing the connection for an ATM based MPLS-LER system including specifying, in advance, routing tags required for transmission between all the input and output FEs installed on the system in order to transmit IP/MPLS packets through the switch fabric; establishing connections, in advance, for transmission and receipt of control messages between the FEs and the IP/MPLS control board through the switch fabric; and, at the time of establishing connections for IP equipments or LSPs, establishing connections for processing the IP/MPLS packets by using the packet transmission method through attachment of the routing tags required for transmission between the FEs and by sharing the connections made between the FEs and IP/MPLS control board.

Preferably, the transmission between the FEs is made without making any separate connections simply by attaching the pre-specified switch fabric routing tags to ATM cells so that the input FEs may transmit IP/MPLS packets to the output FEs through the switch fabric, after receiving the IP/MPLS packets from the input FEs and forwarding them. The connections between the FEs and the IP/MPLS control board are established so that control messages received from the input FEs may be transmitted to the IP/MPLS control board through the switch fabric and, at the same time, the control messages may be transmitted to the output FEs through the switch fabric by the LER control of the IP/MPLS control board.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates the structure of an ATM based MPLS-LER system of the related art;

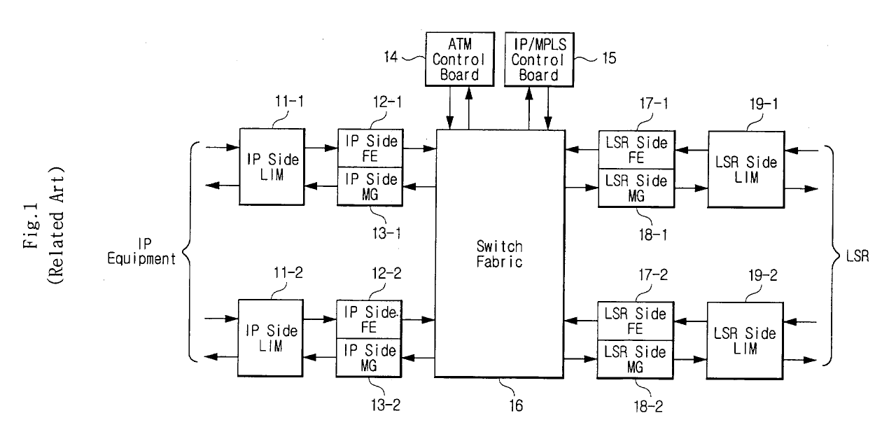

FIG. 2 illustrates a connection established in the ATM based MPLS-LER system in accordance with a preferred embodiment of the present invention;

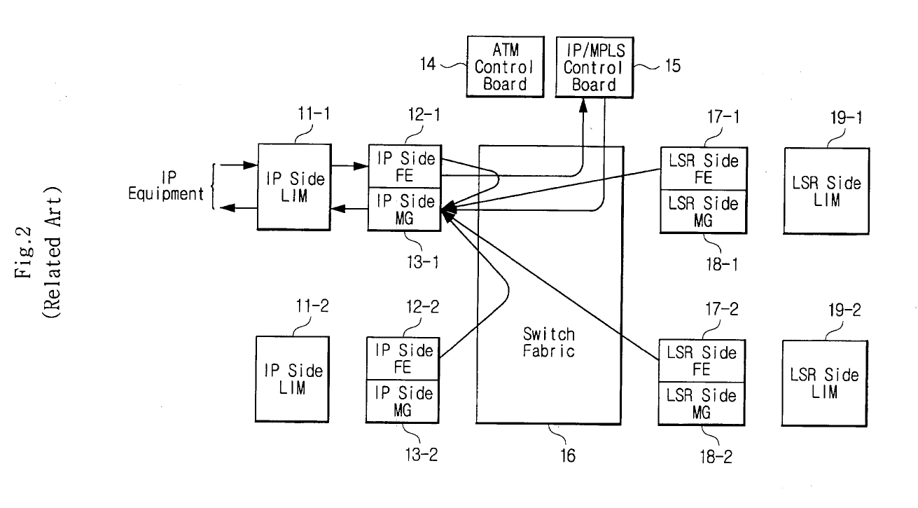

FIG. 3 illustrates the connection established in an ATM based MPLS-LER system in accordance with a preferred embodiment of the present invention for transmission of control messages to and from an LSR;

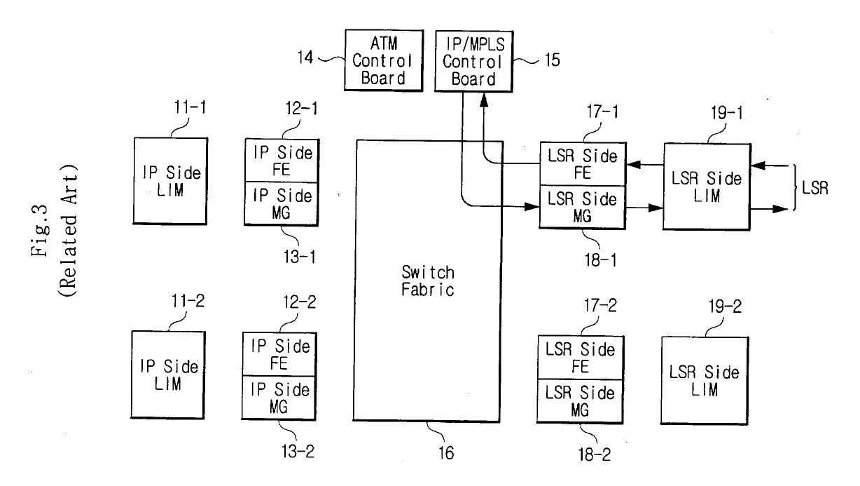

FIG. 4 illustrates the LSP connection structure for transmission of MPLS packets in the ATM based MPLS-LER system in accordance with a preferred embodiment of the present invention;

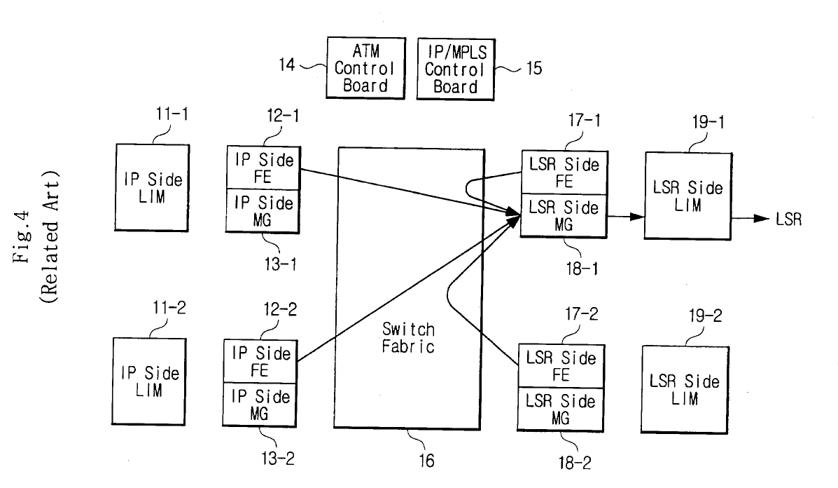

FIG. 5 illustrates the LSP connection structure for receipt of MPLS packets in the ATM based MPLS-LER system in accordance with a preferred embodiment of the present invention;

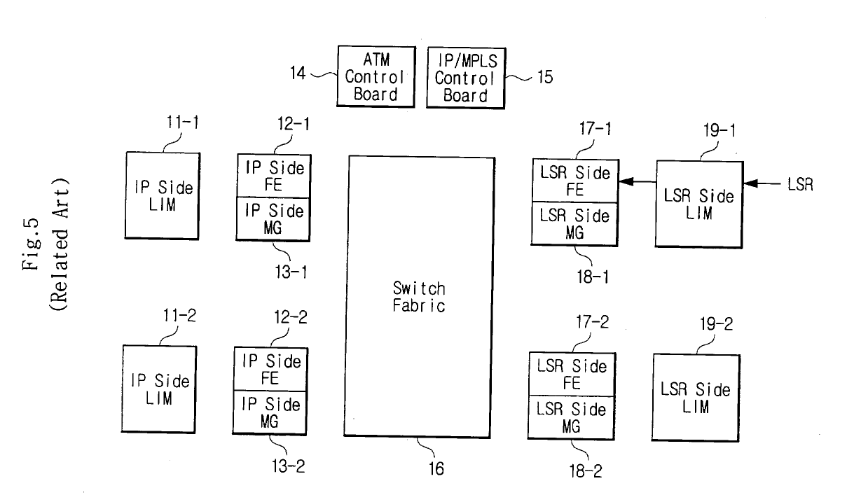

FIG. 6 illustrates the structure of an ATM based MPLS-LER system according to the present invention;

FIG. 7 illustrates the method of transmitting packets segmented into cells through attaching routing tags from the input FEs to the output FEs in accordance with a preferred embodiment of the present invention;

FIG. 8 illustrates the connection structure between the FEs and the IP/MPLS control board in accordance with a preferred embodiment of the present invention;

FIG. 9 illustrates the connection to an IP equipment in accordance with a preferred embodiment of the present invention;

FIG. 10 illustrates the connection for transmitting control messages to and from the LSR in accordance with a preferred embodiment of the present invention;

FIG. 11 illustrates the LSP connection structure for transmitting MPLS packets in accordance with a preferred embodiment of the present invention; and

FIG. 12 illustrates the LSP connection structure for transmitting MPLS packets in accordance with a preferred embodiment of the present invention.

### DETAILED DESCRIPTION OF PREFERRED EMBODIMENTS

The preferred embodiment of the present invention uses Forwarding Engine (FE) boards processing IP/MPLS packets at the output part of an ATM based MPLS-LER system, instead of the conventional (MG) boards conducting (VC) merging function.

Thus, when an IP/MPLS packet is inputted, the input FE conducts the IP header or MPLS label look-up function and determines the destination output FE to which the IP/MPLS packet should be transmitted. When the output FE to which the transmission is to be made is determined, the switch routing tag value required for transmitting the packet to the output FE connected to the next hop device is searched.

Preferably, the IP/MPLS packet is segmented into ATM cells and a routing tag to be referred to by the switch fabric is attached to each of such ATM cells. Then, these ATM cells are transmitted to the switch fabric. For example, a header of 11 bytes containing information regarding a routing tag is attached to an ATM cell and the ATM cell of 64 bytes in total (including the header) is transmitted to the switch fabric. Each one bit of a routing tag indicates one port. Preferably, such routing tag values are specified in advance for all the ports of the switch fabric and are stored in the memory of each FE.

The switch fabric then refers to the routing tag value attached to the ATM cell and accordingly transmits the ATM cell to the relevant output port. In this manner, the ATM cell is transmitted to the output FE attached to the relevant output port.

Thereafter, the output FE reassembles the received ATM cells and constructs the IP/MPLS packet. The output FE then conducts the IP header or MPLS label look-up function again to determine the destination to which the assembled IP/MPLS packet should be transmitted (i.e., search the router connection or the LSP). Thereafter, the IP/MPLS packet is segmented into ATM cells again and such cells are transmitted through the relevant VC connection.

Reference will now be made in detail to preferred embodiments of the present invention as illustrated in the accompanying drawings.

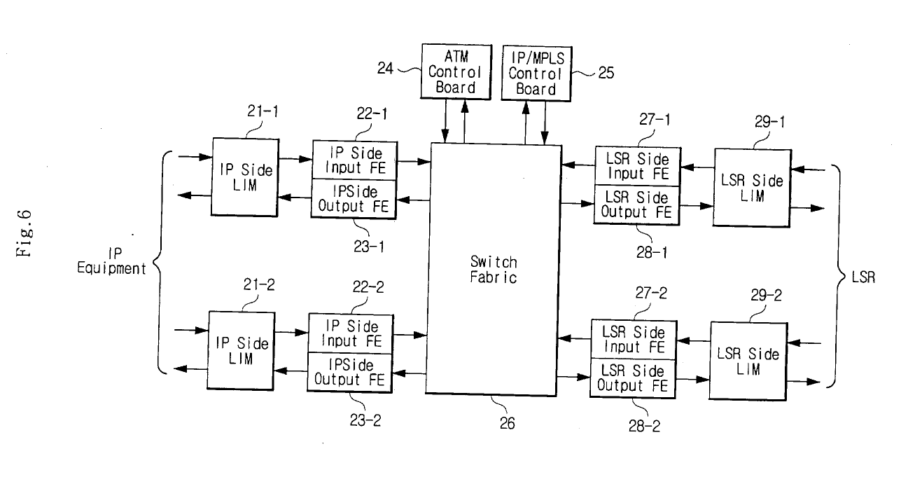

As shown in FIG. 6, an ATM based MPLS-LER system includes a number of LIMs 21-1, 21-2 of the IP side, a number of input FEs 22-1, 22-2 of the IP side, and a number of output FEs 23-1, 23-2 of the IP side. The system further includes an ATM control board 24, an IP/MPLS control board 25, and a switch fabric 26. The system also includes a number of input FEs 27-1, 27-2 of the LSR side, a number of output FEs 28-1, 28-2 of the LSR side, and a number of LIMs 29-1, 29-2 of the LSR side.

The LIMs 21-1, 21-2, 29-1, 29-2 preferably process ATM traffic by matching the system to IP equipments or LSRs. The input FEs 22-1, 22-2, 27-1, 27-2, by conducting the layer 3 forwarding function, transmit IP or MPLS packets received through the LIMs 21-1, 21-2, 29-1, 29-2. For this purpose, the input FEs contain the SAR function to reassemble ATM cells to make a layer 3 packet and to segment a layer 3 packet to form ATM cells for transmission.

The output FEs 23-1, 23-2, 28-1, 28-2, by conducting the layer 3 forwarding function, transmit the IP or MPLS packets received through the switch fabric 26 to the relevant destinations. The output FEs contain the SAR function to reassemble ATM cells to make a layer 3 packet and to segment a layer 3 packet to ATM cells for transmission.

The ATM control board 24 executes software related to call process, connection control, repair and maintenance, billing and statistics for ATM cells. The IP/MPLS control board 25 conducts the LER control function by installing various software containing routing and signaling protocols for managing routing information and TCP/IP protocol stacks. The switch fabric 26 conducts switching and transmission of inputted ATM cells transmitted from the input FEs 22-1, 22-2, 27-1, 27-2 to the output FEs 23-1, 23-2, 28-1, 28-2 via the relevant output ports.

Additional detail regarding the structure of exchange connection for IP/MPLS packet process in an ATM based MPLS-LER system according to the present invention is explained through preferred embodiments.

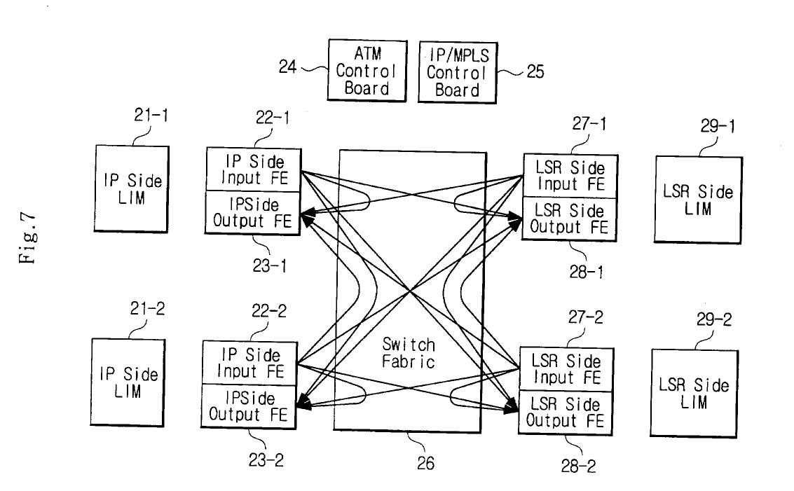

First, for connection of FEs 22-1, 22-2, 23-1, 23-2, 27-1, 27-2, 28-1, 28-2 for the data transmission in the present invention, there is no need for separate connections. Rather, as shown in FIG. 7 of the preferred embodiment, the input FEs 22-1, 22-2, 27-1, 27-2 merely segment a received packet into cells and have the cells transmitted to the switch fabric upon attachment of routing tags to be referred to at the switch fabric. The switch fabric 26 refers to the routing tag attached to a cell and causes the call to be transmitted to the output port corresponding to the routing tag and thus to the relevant FE 23-1, 23-2, 28-1, 28-2.

The structure of routing tags required for transmission of cells to output FEs 23-1, 23-2, 28-1, 28-2 connected to switch output ports is different depending on the manufacturer of switch chip sets. For example, if the routing tag is made in a port-bit-map format, the number of bits required for a routing tag is the number of switch ports. More specifically, if there are 32 switch ports, the routing tag needs to be of 32 bits. The switch fabric 26 may transmit a cell to the designated output port if the relevant bit in the routing tag has been set.

Because the routing tags may be specified in advance according to their relevant structures, they may be used without any separate connection establishment. Thus, if the values of relevant routing tags have been specified and stored in advance within memories of the input FEs 22-1,.22-2, 27-1, 27-2, the routing tags required when cells are transmitted to the relevant output FEs 23-1, 23-2, 28-1, 28-2 are searched and attached to the relevant cells. The routing tag-attached cells are then transmitted through the switch fabric 26.

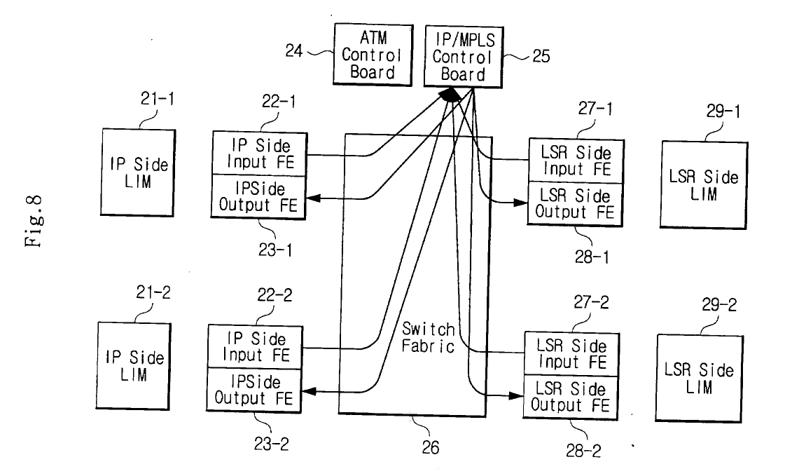

Second, for the connection of the FEs 22-1, 22-2, 23-1, 23-2, 27-1, 27-2, 28-1, 28-2 to the IP/MPLS control board 25, the connections shown in FIG. 8 are made for transmitting control messages (i.e., routing messages and signaling messages) between the FEs 22-1, 22-2, 23-1, 23-2, 27-1, 27-2, 28-1, 28-2 and the IP/MPLS control board 25. Specifically, connections are made so that routing messages and signaling messages received from the input FEs 22-1, 22-2, 27-1, 27-2 may be transmitted to the IP/MPLS control board 25 through the switch fabric 26.

The connections are then made so that the routing messages and signaling messages may be transmitted to the output FEs 23-1, 23-2, 28-1, 28-2 through the switch fabric 26 by the LER control of the IP/MPLS control board 25. Preferably, the connections are utilized for establishing connections for transmission and receipt of control messages to and from the IP equipment or the LSR.

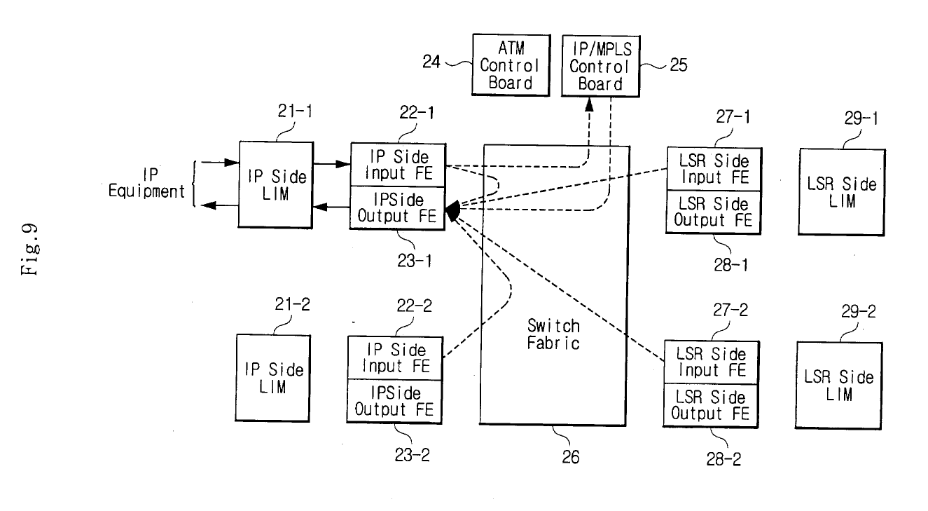

Third, the connection with the IP equipment is explained in more detail. As shown in FIG. 9, the connections are made in order to transmit and receive IP packets to and from the IP equipment connected to the MPLS network. Specifically, a connection is made so that IP packets received from the IP equipment may be processed for ATM traffic at the LIM 21-1 of the IP side and then be transmitted to the input FE 22-1 of the IP side and so that, at the same time, IP packets received through the output FE 23-1 of the IP side may be transmitted to the IP equipment via the LIM 21-1 of the IP side.

Additionally, the preferred embodiment of the present invention utilizes the packet transmission method illustrated in FIG. 7 for data transmission between the FEs 22-1, 22-2, 23-1, 23-2, 27-1, 27-2, 28-1, 28-2 and shares the connections established between the IP/MPLS control board 25 and the FEs 22-1, 22-2, 23-1, 23-2, 27-1, 27-2, 28-1, 28-2 illustrated in FIG. 8. The dotted lines in FIG. 9 indicate such utilization of the packet transmission method shown in FIG. 7 and the connections shown in FIG. 8.

More specifically, after the input FE 22-1 of the IP side conducts the IP header look-up function, a connection is made for transmission to the IP/MPLS control board 25 through the switch fabric 26.

Further, a connection is made so that ATM cells may be transmitted to the output FE 23-1 of the IP side through the switch fabric by the LER control of the IP/MPLS control board 25.

Further, for the receipt, at the output FE 23-1 of the IP side, of ATM cells transmitted from all the input FEs 22-1, 22-2, 27-1, 27-2 through the switch fabric and for transmission, from the output FE 23-1 of the IP side, of the relevant IP packet to its destination after finding such appropriate destination by conducting the IP header look-up function, connections from all the input FEs 22-1, 22-2, 27-1, 27-2 to the output FE 23-1 of the IP side are required. For this purpose, as with the transmission method illustrated in FIG. 7, there is no need for separate connection. Rather, the transmission is made simply by attaching routing tags to relevant data so that the data may be sent to the output FE 23-1 of the IP side.

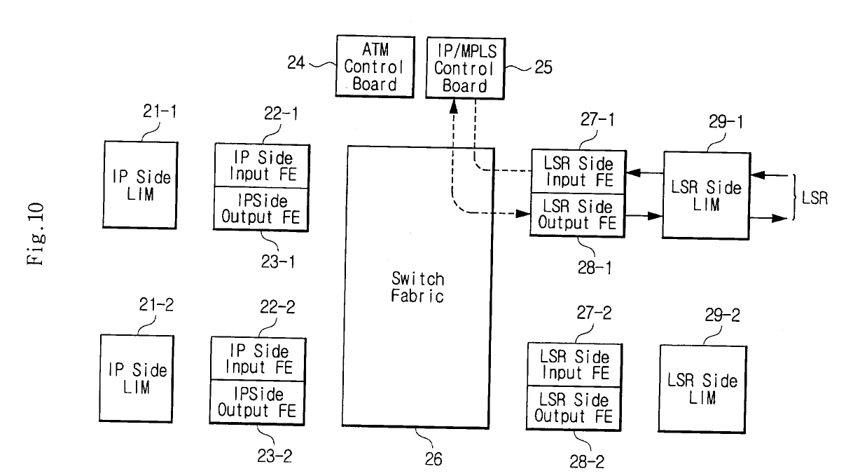

Fourth, for the connection for transmission of control messages to and from the LSR, the following connections are made in order to transmit and receive routing messages and signaling messages to and from the LSR of the MPLS network as shown in FIG. 10.

Specifically, a connection is made so that routing messages and signaling messages received through the output FE 28-1 of the LSR side may be transmitted to the LSR via the LIM 29-1 of the LSR side and so that, at the same time, routing messages and signaling messages received from the LSR may be transmitted to the input FE 27-1 of the LSR side through the LIM 29-1 of the LSR side.

Additionally, the connections established between the IP/MPLS control board 25 and the FEs 22-1, 22-2, 23-1, 23-2, 27-1, 27-2, 28-1, 28-2 as illustrated in FIG. 8 are utilized through sharing the connections. The dotted lines in FIG. 10 indicate such utilization of the connections shown in FIG. 8.

More specifically, a connection is made for transmitting routing messages and signaling messages to the output FE 28-1 of the LSR side through the switch fabric 26 by the LER control of the IP/MPLS control board 25.

Further, a connection is made for transmitting routing messages and signaling messages received through the input FE 27-1 of the LSR side to the IP/MPLS control board 25 via the switch fabric 26.

Fifth, for the LSP connection for MPLS packet transmission, the following connections are made in order to transmit MPLS packets in the ATM cell format to the LSR of the MPLS network are described in more detail below.

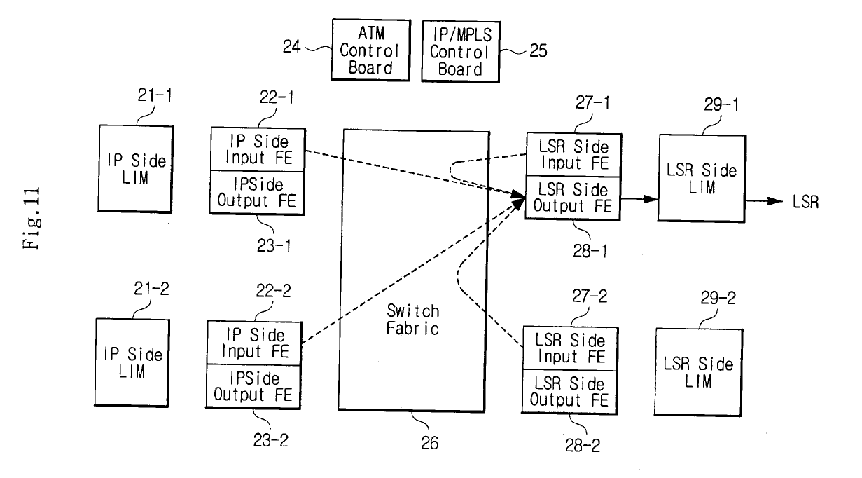

As shown in FIG. 11, the packet transmission method of data transmissions between the FEs 22-1, 22-2, 23-1, 23-2, 27-1, 27-2, 28-1, 28-2 is utilized in this connection. The dotted lines in FIG. 11 indicate such utilization of the packet transmission method shown in FIG. 7. Specifically, for the connection for transmission from the IP equipment to the output FE 28-1 of the LSR side, the packet transmission method using the routing tags shown in FIG. 7 is used. The only connection that needs to be made for the purpose of the LSP connection is the connection for transmitting MPLS packets from the output FE 28-1 of the LSR side to the LSR via the LIM 29-1 of the LSR side upon searching a destination at the output FE 28-1 of the LSR side by conducting the IP header look-up function.

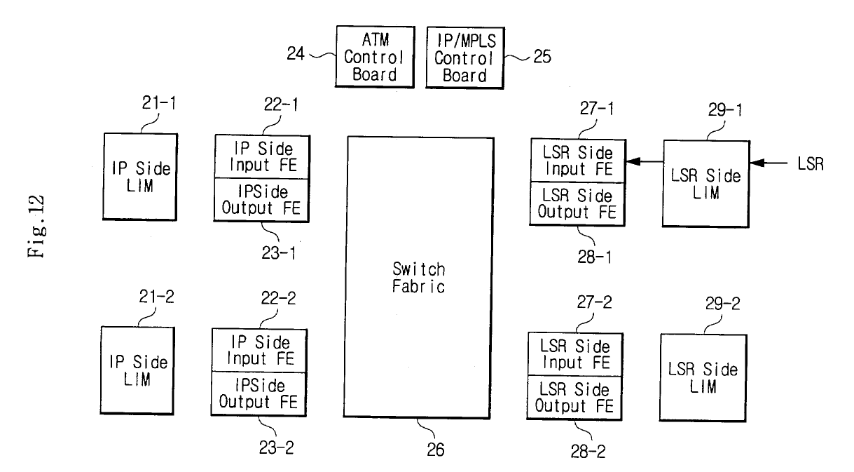

Sixth, for the LSP connection for receiving MPLS packets, the following connection illustrated in FIG. 12 is made in order to receive MPLS packets in the ATM cell format from the LSR of the MPLS network.

The connection made for this purpose is the same as the connection made in the related art. Specifically, a connection is made for ATM traffic processing of MPLS packets of the ATM cell format received from the LSR at the LIM 29-1 of the LSR side and for transmitting such MPLS packets to the input FE 27-1 of the LSR side.

As described above, an ATM based MPLS-LER system according to the preferred embodiment has various advantages. For example, the system establishes connections with additional IP equipments or LSPs for IP/MPLS packet transmission by utilizing pre-established internal connection. Thus, the number of connections required within the switch does not need to be increased for additional connections made within the system, while all the connections supported by the LIMs may be established. As a result, the number of connections required overall according to the present invention is conspicuously less than the number of connections required in the related art, which is the number of connections required in the present invention multiplied by the number of FEs. Consequently, the repair and maintenance of connections become simple according to the present invention.

Further, with respect to connections required to be made for additional IP equipments or LSPs separately from the pre-established connections which have been established in an ATM based MPLS-LER system of the present invention, all such connections are made limitedly at the FEs of the present invention. Thus, the connections are made in a simple and expeditious manner.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. An Asynchronous Transfer Mode (ATM) based Multi Protocol Label Switching (MPLS)—Label Edge Router (LER) system, comprising:
a plurality of Line Interface Modules (LIMs) configured to process ATM traffic by matching the ATM traffic with an Internet Protocol (EP) equipment and Label Switching Router (LSR); and
a plurality of input Forwarding Engines (FEs) configured to transmit one of IP and MPLS packet received through at least one of the plurality of LIMs to prescribed destinations by conducting a forwarding function without being individually connected to each of the plurality of LIMs.

2. The system of claim 1, further comprising:
a switch fabric configured to transmit the ATM cells from the plurality of input FEs to a prescribed output port to perform ATM cell switching; and
a plurality of output FEs configured to transmit one of the IP and MPLS packets received through the switch fabric to the prescribed destinations using the LIM by conducting the forwarding function.

3. The system of claim 2, wherein the plurality of input FEs configured to be installed at an input part.

4. The system of claim 3, wherein the plurality of input FEs configured to be installed at the input part are configured to transmit one of the IP and MPLS packets, which has been received through the relevant LIMs to the plurality of output FEs using the switch fabric by conducting one of an IP header and MPLS label look-up function.

5. The system of claim 2, wherein the plurality of output FEs configured to be are installed at an output part.

6. The system of claim 5, wherein the plurality of output FEs are configured to transmit one of the IP and MPLS packets, which have been received through the switch fabric, to destinations searched by the IP header or MPLS label look-up function using the relevant LIMs.

7. The system of claim 2, wherein the plurality of input FEs are configured to attach a prescribed routing tag, at the switch fabric, to the ATM cells.

8. The system of claim 7, wherein the plurality of input FEs are configured to transmit the prescribed routing tag attached to the ATM cells to the output FEs.

9. The system of claim 7, wherein the prescribed routing tag attached to the ATM cells is configured to transmit one of the IP and MPLS packets, which have been received through the LIMs.

10. The system of claim 2, wherein the plurality of input FEs and the plurality of output FEs establish a connection for a transmission and a receipt of a control message to and from an IP/MPLS board.

11. A method for establishing connections of an Asynchronous Transfer Mode (ATM) based Multi Protocol Label Switching (MPLS)—Label Edge Router (LER) ATM based MPLS-LER system comprising:
specifying, in advance, routing tags required for transmission between a plurality of input and a plurality of output forwarding engines (FEs) installed on a system in order to transmit an Internet Protocol/multi protocol label switching (IP/MPLS) packet through a switch fabric;
pre-establishing connections, for the transmission and the receipt of the control message between the plurality of input and plurality of output FEs and the IP/MPLS control board through a switch fabric; and
establishing connections, at the time of establishing connections for at least one of IP equipment and LSPs, for processing the IP/MPLS packets by using a packet transmission through an attachment of the routing tags required for the transmission between the plurality of input and plurality of output FEs and by sharing the connections made between the plurality of input and plurality of output FEs and the IP/MPLS control board.

12. The method of claim 11, wherein the transmission between the plurality of input and plurality of output FEs comprises attaching a prescribed switch fabric routing tag to an ATM cell so that the plurality of input FEs may transmit IP/MPLS packets to the plurality of output FEs through the switch fabric, after receiving the IP/MPLS packets from the plurality of input FEs and forwarding the plurality of input FEs.

13. The method of claim 11, wherein the connections between the plurality of input and plurality of output FEs and the IP/MPLS control board further comprises simultaneously transmitting control messages from the plurality of input FEs to the IP/MPLS control board through the switch fabric and transmitting the control messages to the plurality of output FEs through the switch fabric by the LER control of the IP/MPLS control board.

14. The method of claim 11, wherein the connections for processing the IP/MPLS packets comprise, at the time of establishing connections with an IP equipment:
using a packet transmission through attaching routing tags required for transmission between the plurality of input and plurality of output FEs and sharing the connections made between the plurality of input and plurality of output FEs and the IP/MPLS control board; and
establishing a connection for transmission of IP packets that are received from the IP equipment to an input FE of the IP side via the LIM of the IP side; and establishing a connection for transmission of IP packets that are received through the plurality of output FEs of the IP side to the IP equipment via the LIM of the IP side.

15. The method of claim 11, wherein the connections for processing the IP/MPLS packets comprise:
sharing, at the time of transmitting control messages to an LSR, the connections made between the plurality of input and plurality of output FEs and the IP/MPLS control board;
establishing, at the time of transmitting control messages to an LSR, a connection so that control messages received through an output FE of the LSR side may be transmitted to the LSR using the LIM of the LSR side; and
establishing, at the time of transmitting control messages to an LSR, a connection for transmitting control messages received from the LSR to an input FE of the LSR side via the LIM of the LSR side.

16. The method of claim 11, wherein the connections for processing the IP/MPLS packets comprise:
using, at the time of the LSP connection for transmitting MPLS packets, the packet transmission method through attaching routing tags required for transmission between the plurality of input and plurality of output FEs; and
establishing, at the time of the LSP connection for transmitting MPLS packets, a connection for transmitting MPLS packets received from the output FE of the LSR side to the LSR via the LIM of the LSR side.
